(19) United States
(12) Patent Application Publication
(10) Pub. No.: US 2023/0109696 A1
(43) Pub. Date: Apr. 13, 2023

(54) COATING COMPOSITION, A COATING COMPOSITION FOR AN OUTER WALL OR EXTERIOR OF BUILDING, AND AN ARTICLE COMPRISING THE COATING COMPOSITION

(71) Applicant: Nissin Chemical Industry Co., Ltd., Echizen-shi (JP)

(72) Inventors: Koji Yamazaki, Echizen-shi (JP); Kentaro Watanabe, Echizen-shi (JP)

(21) Appl. No.: 17/934,304

(22) Filed: Sep. 22, 2022

(30) Foreign Application Priority Data
Sep. 24, 2021 (JP) 2021-155548

(51) Int. Cl. C09D 183/06; C09D 5/02; C09D 7/40; C09D 7/61

(52) U.S. Cl. CPC C09D 183/06; C09D 5/024; C09D 7/61; C09D 7/68; C09D 7/69

(57) ABSTRACT

The present invention provides a coating composition wherein the coating composition comprises the following components (A) and (B): (A) an emulsion of a silicone acrylic copolymer resin having a glass transition temperature of 0° C. or higher and being a copolymer of 40 to 90 parts by mass of (a1) a polyorganosiloxane represented by the formula (1) with 10 to 60 parts by mass of (a2) a methacrylic acid ester monomer, provided that a total amount of components (a1) and (a2) is 100 parts by mass; the emulsion being in an amount of 5 to 80 parts by mass as a solid content, and (B) a metal oxide in an amount of 20 to 95 parts by mass, provided that a total mass of the solid content of component (A) and component (B) is 100 parts by mass.

### CROSS REFERENCE

This application claims the benefits of Japanese Patent Application 2021-155548 filed on Sep. 24, 2021, the contents of which are hereby incorporated by reference.

### BACKGROUND OF THE INVENTION

The present invention relates to a coating composition, in particular, a heat shielding coating composition for coating outer walls and building exteriors, more specifically, a heat shielding coating composition which is to be applied on a substrate such as ceramic building material (such as siding board), concrete, wood substrate, metal substrate, or mortar substrate to reflects near-infrared rays and suppress the temperature rise in a room due to direct sunlight. The present invention relates also to an article having a coating formed from the aforesaid coating composition.

In the field of coatings for outer walls or building exteriors, oxides of a metal selected from the group consisting of silicon, aluminum, zirconium, titanium, zinc, germanium, indium, tin, antimony and cerium are known as components that block infrared rays for the purpose of saving energy and improving environment of living. Further, water-based coating compositions are being used to reduce VOCs in the atmosphere and there is a demand for water-based coating compositions that have high heat-shielding performance and excellent coating film performance.

A dispersion medium has recently been changed from an organic solvent-based one to a water-based one in consideration of environmental problems. In particular, volatile organic compounds may cause sick house syndrome, so that water-based coatings are eagerly desired. Acrylic resins, urethane resins and alkyd resins have excellent film-forming ability and, therefore, have been used widely as a binder resin for water-based coatings. Silicone resins are known to give a substrate a sliding property and water repellency.

For example, Japanese Patent Application Laid-Open No. 2007-146062 (Patent Literature 1) describe a heat-shielding water-based coating composition comprising an acrylic ester polymer in combination with an amine polymer that dries quickly and has a reflectance of 30% or more. However, a coating film obtained from the composition described in Patent Literature 1 has poor feel of the surface, that is, poor slippery of the surface, and has no water-repellency, so that is not suitable for exterior wall coating composition.

Japanese Patent Application Laid-Open No. 2014-196401(Patent Literature 2) describes an aqueous heat-shielding coating material comprising an acrylic polymer having an OH value as an aqueous resin dispersion. The coating composition is inferior in feel of the surface and water-repellency of the coating film, and is not suitable for exterior wall coating composition.

WO2013/129488 (Patent Literature 2) describes a water-based heat-shielding coating material having low contamination property, in particular a coating composition having low-contamination property and a hydrophilic surface via an acrylic silica-based resin which is formed by reacting a core-shell type acrylic resin with a silicate. Since the coating composition contains silicate, the surface of the coating is not slippery and the feel is poor. In addition, the coating composition has no water repellency, so that antifouling property cannot be expected and there is room for improvement.

Japanese Patent Application Laid-Open Nos. 2005-120278(Patent Literature 4) and 2009-013379(Patent Literature 5) describe compositions containing silicone emulsions, inorganic fillers, and metal oxides. However, the silicone emulsions described in these Patent Literatures may aggregate when mixed with an inorganic filler or metal oxide, so that there is room for improvement.

### PRIOR LITERATURES

### Patent Literatures

Patent Literature 1: Japanese Patent Application Laid-Open No. 2007-146062
Patent Literature 2: Japanese Patent Application Laid-Open No. 2014-196401
Patent Literature 3:WO2013/129488
Patent Literature 4: Japanese Patent Application Laid-Open No. 2005-120278
Patent Literature 5: Japanese Patent Application Laid-Open No. 2009-013379

### SUMMARY OF THE INVENTION

### Problems to Be Solved by the Invention

The purpose of the present invention is to provide a coating composition which gives a substrate excellent feel and heat shielding properties, a coating formed from the aforesaid coating composition, and an article, in particular a building material for outer walls and building exteriors comprising the article, which article has a coating formed from the aforesaid coating composition.

The present inventors conducted keen researches to solve the aforesaid problems and have found that a coating composition comprising (A) a specific silicone acrylic copolymer resin emulsion and (B) a metal oxide in a predetermined proportion and a coating formed from the aforesaid coating composition are suited as a coating composition of shielding solar heat for outer walls and building exteriors.

That is, the present invention provides a coating composition wherein the coating composition comprises the following components (A) and (B),
(A) an emulsion of a silicone acrylic copolymer resin having a glass transition temperature of 0° C. or higher and being a copolymer of 40 to 90 parts by mass of (a1) a polyorganosiloxane represented by the following formula (1) with 10 to 60 parts by mass of (a2) a methacrylic acid ester monomer, provided that a total amount of components (a1) and (a2) is 100 parts by mass,

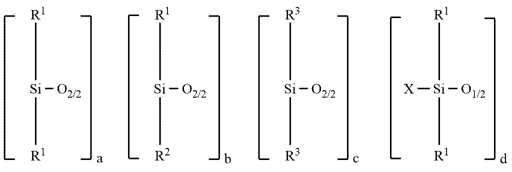

wherein R¹ is, independently of each other, a substituted or unsubstituted monovalent hydrocarbon group having 1 to 20 carbon atoms, precluding the groups defined for R² and a phenyl group; R² is, independently of each other, an alkenyl group having 2 to 6 carbon atoms or an alkyl group which has 1 to 6 carbon atoms and of which a part of the hydrogen atoms bonded to the carbon atom is substituted with a mercapto group, a vinyl group, an acryloxy group, or a methacryloxy group; R³ is, independently of each other, a phenyl group or the group defined for R¹, and at least one of R³s bonded to the same silicon atom is a phenyl group; and X is, independently of each other, a substituted or unsubstituted monovalent hydrocarbon group having 1 to 20 carbon atoms, an alkoxy group having 1 to 20 carbon atoms, or a hydroxyl group; a, b, c and d are the number satisfying equations, 0.11≤-a/(a+b+c+d)<1, 0.00001≤b/(a+b+c+d)≤0.05, 0≤c/(a+b+c+d)≤0.6, and 0.000001≤d/(a+b+c+d)≤0.24;
the emulsion being in an amount of 5 to 80 parts by mass as a solid content, and
(B) a metal oxide in an amount of 20 to 95 parts by mass,
provided that a total mass of the solid content of component (A) and component (B) is 100 parts by mass.

### Effects of the Invention

The coating composition of the present invention forms a coating having heat shielding property, excellent feel and water repellency. The aforesaid coating gives excellent heat shielding property, excellent feel and water repellency to a substrate while maintaining the design specific to the substrate. The coating composition of the present invention is water-based and, therefore, advantageous from the standpoints of workability and environment. The coating composition also has excellent storage stability. The water-based coating composition of the present invention is suited for an outer wall coating to suppress temperature rising by solar heat.

### DETAILED DESCRIPTION OF THE INVENTION

The components will be described below in detail.

### (A) Emulsion of Silicone Acrylic Copolymer Resin

Component (A) is an emulsion of a silicone acrylic copolymer resin comprised of 40 to 90 parts by mass of (a1) a polyorganosiloxane represented by the following formula (1) and 10 to 60 parts by mass of (a2) a methacrylic acid ester monomer, provided that a total amount of components (a1) and (a2) is 100 parts by mass,

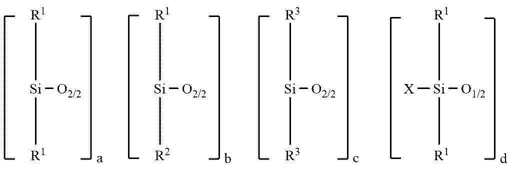

wherein R¹ is, independently of each other, a substituted or unsubstituted monovalent hydrocarbon group having 1 to 20 carbon atoms, precluding the groups defined for R² and a phenyl group; R² is, independently of each other, an alkenyl group having 2 to 6 carbon atoms or an alkyl group which has 1 to 6 carbon atoms and of which a part of the hydrogen atoms bonded to the carbon atom is substituted with a mercapto group, a vinyl group, an acryloxy group, or a methacryloxy group; R³ is, independently of each other, a phenyl group or the group defined for R¹, and at least one of R³ s bonded to the same silicon atom is a phenyl group; and X is, independently of each other, a substituted or unsubstituted monovalent hydrocarbon group having 1 to 20 carbon atoms, an alkoxy group having 1 to 20 carbon atoms, or a hydroxyl group; a, b, c and d are the number satisfying equations, 0.11≤a/(a+b+c+d)≤1, 0.00001≤b/(a+b+c+d)≤0.05, 0≤c/(a+b+c+d)≤0.6, and 0.000001≤d/(a+b+c+d)≤0.24.

More specifically, component (A) is an emulsion of a silicone acrylic copolymer resin obtained by the emulsion graft polymerization of the polyorganosiloxane (a1) represented by the above formula (1) and the methacrylic acid ester monomer (a2).

The mass ratio of the component (a1) and component (a2) is preferably such that the amount of component (a1) is 40 to 90 parts by mass and the amount of component (a2) is 10 to 60 parts by mass, relative to total 100 parts by mass of components (a1) and (a2). Further preferably, the amount of component (a1) is 50 to 90 parts by mass and the amount of component (a2) is 10 to 50 parts by mass.

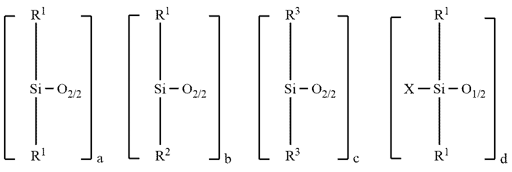

R¹ is, independently of each other, a substituted or unsubstituted, monovalent hydrocarbon group having 1 to 20, preferably 1 to 10, more preferably 1 to 6 carbon atoms. Examples of the monovalent hydrocarbon group include alkyl groups such as methyl, ethyl, propyl, butyl, pentyl, hexyl, heptyl, octyl, nonyl, decyl, dodecyl, tetradecyl, hexadecyl, and octadecyl groups; cycloalkyl groups such as cyclopentyl, cyclohexyl, and cycloheptyl groups; aryl groups such as tolyl and naphthyl groups; alkenylaryl groups such as a vinylphenyl group; aralkyl groups such as benzyl, phenylethyl, and phenylpropyl groups; and alkenylaralkyl groups such as vinylbenzyl and vinylphenylpropyl groups; and those groups in which a part or all of the hydrogen atoms are substituted with a halogen atom such as fluorine, bromine, or chlorine, a carboxyl group, an alkoxy group, an alkenyloxy group, or an amino group. R¹ is preferably an unsubstituted alkyl group having 1 to 6 carbon atoms, more preferably a methyl group.

R² is, independently of each other, an alkenyl group having 2 to 6 carbon atoms or an alkyl group which has 1 to 6 carbon atoms and of which a part of the hydrogen atoms bonded to a carbon atom is substituted with a mercapto group, a vinyl group, an acryloxy group, or a methacryloxy group. Examples of the alkenyl group having 2 to 6 carbon atoms include vinyl and allyl groups. R² is preferably an alkyl group having 1 to 6 carbon atoms and having an acryloxy or methacryloxy group. The aforesaid alkyl group is preferably a methyl group, an ethyl group, or a propyl group. R³ is, independently of each other, a phenyl group or the aforesaid group defined for R¹. At least one of R³ bonded to the same silicon atom is a phenyl group.

X is, independently of each other, a substituted or unsubstituted, monovalent hydrocarbon group having 1 to 20, preferably 1 to 10, more preferably 1 to 6 carbon atoms; an alkoxy group having 1 to 20, preferably 1 to 10, more preferably 1 to 4 carbon atoms; or a hydroxyl group. Examples of the substituted or unsubstituted monovalent hydrocarbon group having 1 to 20 carbon atoms include the aforesaid groups defined for R¹. Examples of the alkoxy group having 1 to 20 carbon atoms include methoxy, ethoxy, propoxy, butoxy, hexyloxy, heptyloxy, octyloxy, decyloxy, and tetradecyloxy groups. X is preferably a hydroxyl, methoxy, ethoxy, methyl, butyl, or phenyl group. In particular, X is a hydroxyl, methoxy or ethoxy group.

In the formula (1), a, b, c, and d are the real number. “a” satisfies the following equation, 0.11≤a/(a+b+c+d)<1 (for example, 0.999999 or less), preferably 0.59≤a/(a+b+c+d) ≤0.99998. b satisfies the following equation, 0.00001≤b/(a+b+c+d)≤0.05, preferably 0.00001≤b/(a+b+c+d)≤0.01. c satisfies the following equation, 0≤c/(a+b+c+d)≤0.6, preferably 0≤c/(a+b+c+d)≤0.30. d satisfies the following equation, 0.000001≤d/(a+b+c+d)≤0.24, preferably 0.00001≤d/(a+b+c+d)≤0.1. If b/(a+b+c+d) exceeds 0.05, the feel of a coated film is not improved and the stain resistance is worse. If d/(a+b+c+d) exceeds 0.24, a weight average molecular is too small and the feel is not improved, which is not preferred. c is the number of the siloxane units having a phenyl group. On account of c being within the aforesaid range, the coating has preferable transparency and heat resistance.

The polyorganosiloxane (a1) has a weight average molecular weight of 5,000 to 500,000, preferably 8,000 to 450,000, more preferably 100,000 to 450,000, still more preferably 150,000 to 400,000. If the polyorganosiloxane has the aforesaid weight average molecular weight, a coating agent provides a good sliding property peculiar to silicones.

Here, the molecular weight of the polyorganosiloxane is calculated from the specific viscosity, nsp, at 25° C. of a 1 _{g}/100 ml solution of the polyorganosiloxane in toluene.

$$\text{η} \text{sp} = \left(\text{η} / \text{η} 0\right) - 1$$

(η0: viscosity of toluene, η: viscosity of the solution)

$$\text{η} \text{sp} = \left[\text{η}\right] + 0.3 \left[\text{η}\right] \text{square}$$

$$\left[\text{η}\right] = 2.15 \times {10}^{- 4} {\text{M}}^{0.65}$$

More specifically, 20 g of the emulsion is mixed with 20 g of IPA (isopropyl alcohol) to break the emulsion and, then, IPA is removed and a residual rubbery polyorganosiloxane is dried at 105° C. for 3 hours. The resulting polyorganosiloxane is dissolved in toluene in a concentration of 1 g/100 ml. A viscosity of the solution is determined at 25° C. by a Ubbelohde viscometer. The molecular weight is calculated by substituting the viscosity in the aforesaid equation (Reference: Nakamuta, Journal of the Chemical Society of Japan, 77, 858 [1956]; Doklady Akad. Nauk. U.S.S.R. 89 65 [1953]).

The aforesaid polyorganosiloxane (a1) is preferably in a form of an emulsion and may be a commercially available product or may be synthesized in house. The polyorganosiloxane (a1) may be easily synthesized in any known emulsion polymerization method. For example, a cyclic organosiloxane which may have a fluorine atom, a (meth)acryloxy group, a carboxyl group, a hydroxyl group, or an amino group, or an α,ω-dihydroxysiloxane oligomer, an α,ω⁻ dialkoxysiloxane oligomer, or an alkoxysilane and a silane coupling agent represented by the following formula (2) are emulsified and dispersed in water with an anionic surfactant and, then, polymerized, if needed, in the presence of a catalyst such as an acid to obtain the polyorganosiloxane (a1).

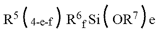

wherein R⁵ is a monovalent organic group having a polymerizable double bond, specifically an alkyl group which has 1 to 6 carbon atoms and is substituted with an acryloxy or methacryloxy group; R⁶ is an alkyl group having 1 to 4 carbon atoms; R⁷ is an alkyl group having 1 to 4 carbon atoms; e is an integer of 2 or 3; f is an integer of 0 or 1; and e+f = 2 or 3.

Examples of the aforesaid cyclic organosiloxane include hexamethylcyclotrisiloxane (D3), octamethylcyclotetrasiloxane (D4), decamethylcyclopentasiloxane (D5), dodecamethylcyclohexasiloxane (D6), 1,1-diethylhexamethylcyclotetrasiloxane, phenylheptamethylcyclotetrasiloxane, 1,1-diphenylhexamethylcyclotetrasiloxane, 1,3,5,7-tetravinyltetramethylcyclotetrasiloxane, 1,3,5,7-tetramethylcyclotetrasiloxane, 1,3,5,7-tetracyclohexyltetramethylcyclotetrasiloxane, tris(3,3,3-trifluoropropyl)trimethylcyclotrisiloxane, 1,3,5,7-tetra(3-methacryloxypropyl)tetramethylcyclotetrasiloxane, 1,3,5,7-tetra(3-acryloxypropyl)tetramethylcyclotetrasiloxane, 1,3,5,7-tetra(3-carboxypropyl)tetramethylcyclotetrasiloxane, 1,3,5,7-tetra(3-vinyloxypropyl)tetramethylcyclotetrasiloxane, 1,3,5,7-tetra(p-vinylphenyl)tetramethylcyclotetrasiloxane, 1,3,5,7-tetra[3-(p-vinylphenyl)propyl]tetramethylcyclotetrasiloxane, 1,3,5,7-tetra(N-acryloyl-N-methyl-3-aminopropyl)tetramethylcyclotetrasiloxane, and 1,3,5,7-tetra(N,N-bis(lauroyl)-3-aminopropyl)tetramethylcyclotetrasiloxane. Octamethylcyclotetrasiloxane and decamethylcyclopentasiloxane are preferred.

Examples of the silane coupling agent include acrylic silanes such as y-(meth)acryloxypropyltrimethoxysilane, y-(meth)acryloxypropyltriethoxysilane, y-(meth)acryloxypropyltripropoxysilane, y-(meth)acryloxypropyltriisopropoxysilane, y-(meth)acryloxypropyltributoxysilane, y-(meth)acryloxypropylmethyldimethoxysilane, y-(meth)acryloxypropylmethyldiethoxysilane, y-(meth)acryloxypropylmethyldipropoxysilane, y-(meth)acryloxypropylmethyldiisopropoxysilane, and y-(meth)acryloxypropylmethyldibutoxysilane; and mercaptosilanes such as y-mercaptopropylmethyldimethoxysilane and y-mercaptopropyltrimethoxysilane. Oligomers obtained by the condensation polymerization of the aforesaid silanes are sometimes preferred for decreasing the generation of an alcohol. In particular, acrylic silanes are preferred. The (meth)acryloxy herein means acryloxy or methacryloxy. These silane coupling agents are preferably used in an amount of 0.01 to 10 parts by mass, more preferably 0.01 to 5 parts by mass, relative to 100 parts by mass of the cyclic organosiloxane. If the amount is less than 0.01 part by mass, the transparency of the coating agent thus obtained is lower. If the amount is more than 10 parts by mass, the coating agent may not have a sliding property.

On account of copolymerizing the cyclic organosiloxane with the aforesaid silane coupling agent, a polymerizable group (R²) is introduced onto the polyorganosiloxane and, thereby, the (meth)acrylic acid ester monomer (a2) may be grafted on the polyorganosiloxane (a1).

The polymerization catalyst used for the polymerization may be any known polymerization catalysts. Among them, strong acids are preferred such as hydrochloric acid, sulfuric acid, dodecylbenzenesulfonic acid, citric acid, lactic acid, and ascorbic acid. Dodecylbenzenesulfonic acid has an emulsifying ability and is preferred.

The acid catalyst is preferably used in an amount of 0.01 to 10 parts by mass, more preferably 0.2 to 2 parts by mass, relative to 100 parts by mass of the cyclic organosiloxane.

Examples of the surfactant to be used in the polymerization include anionic surfactants such as sodium lauryl sulfate, sodium laurate sulfate, N-acylamino acid salts, N-acyl taurine salts, aliphatic soaps, and alkyl phosphates. Preferred are anionic surfactants which are easily soluble in water and have no polyethylene oxide chain. More preferred are N-acylamino acid salts, N-acyl taurine salts, aliphatic soaps, and alkyl phosphates, and particularly preferred are sodium methyl lauroyl taurate, sodium methyl myristoyl taurate, and sodium lauryl sulfate.

The anionic surfactant is preferably used in an amount of 0.1 to 20 parts by mass, more preferably 0.5 to 10 parts by mass, relative to 100 parts by mass of the cyclic organosiloxane.

The polymerization temperature is preferably 50 to 75° C. and the polymerization time is preferably 10 hours or more, more preferably 15 hours or more. Further, the polymerization is preferably followed by aging at 5 to 30° C. for 10 hours or more.

The methacrylic acid ester (a2) (hereinafter, referred to as “acrylic component”) is a linear or branched alkyl ester having 1 to 20 carbon atoms, preferably 1 to 6 carbon atoms, more preferably 1 to 3 carbon atoms; and may have a functional group such as an amide, vinyl, carboxyl, or hydroxyl group. Examples of the methacrylic acid ester include methyl methacrylate, ethyl methacrylate, butyl methacrylate, and 2-ethylhexyl methacrylate. One or more of these esters may be copolymerized. Methyl acrylate, ethyl acrylate, methyl methacrylate, or ethyl methacrylate is preferred. The methacrylic acid ester may preferably have a glass transition temperature (hereinafter, referred to as “Tg”) of 120° C. or lower, more preferably 110° C. or lower. The lower limit is preferably -50° C. Component (a2) is selected for the graft copolymerization so as to provide a silicone acrylic copolymer resin having a Tg of 0° C. or higher, more preferably 5° C. or higher. On account of the silicone acrylic resin copolymer having the aforesaid Tg, the stain resistance of a resin obtained is increased.

The aforesaid graft copolymerization of the polyorganosiloxane (a1) and the (meth)acrylic acid ester monomer (a2) may be conducted according to any conventional method. For example, a radical initiator may be used. The radical initiator is not particularly limited. Examples of the radical initiator include persulfates such as potassium persulfate and ammonium persulfate, aqueous hydrogen persulfate, t-butyl hydroperoxide, and hydrogen peroxide. A redox system with a reducing agent such as sodium bisulfite, Rongalite, L-ascorbic acid, tartaric acid, saccharides, and amines may be used in combination with the aforesaid radical initiator if necessary.

An anionic surfactant such as sodium lauryl sulfate, sodium laureth sulfate, N-acylamino acid salt, N-acyl taurine salt, aliphatic soap, or an alkyl phosphate may be added in order to improve the stability of the emulsion. A nonionic emulsifier such as polyoxyethylene lauryl ether or polyoxyethylene tridecyl ether may also be added.

Further, a chain transfer agent may be added to control the molecular weight.

The silicone acrylic copolymer resin emulsion (A) preferably has a solid content of 35 to 50 mass% and a viscosity (25° C.) of 500 mPa·s or less, more preferably 20 to 300 mPa·s. The viscosity may be determined with a rotational viscometer. The emulsion particles have an average particle diameter of 1000 nm or less, preferably 100 nm to 500 nm, more preferably 150 to 350 nm. If the average particle diameter is too large, whitening is observed. If the average particle diameter is too small, dispersibility is lower. The particle diameter of the resin emulsion is determined by JEM-2100TM, ex JEOL.

The solid content of the silicone acrylic copolymer resin emulsion (A) is preferably 5 to 80 parts by mass, more preferably 10 to 80 parts by mass, still more preferably 10 to 75 parts by mass, relative to total 100 parts by mass of the solid content of component (A), and the component (B). If the solid content of component (A) is less than the aforesaid lower limit, feel or stain resistance is not sufficient. If the solid content of component (A) is more than the aforesaid upper limit, the surface of the coating film is easily stained. The silicone acrylic copolymer resin (A) preferably has a glass transition temperature (hereinafter, referred to as “Tg”) of 0° C. or higher, more preferably 5° C. or higher.

The glass transition temperature (T) of the copolymer resin is calculated according to the following equation:

$$\left(\text{Pa+Pb+Pc}\right) / \text{T=} \left(\text{Pa/Ta}\right) + \left(\text{Pb/Tb}\right) + \left(\text{Pc/Tc}\right)$$

In the above equation, T is a glass transition temperature (K) of polymer particles, Pa, Pb, and Pc are contents (mass%) of the monomers a, b, and c, respectively, and Ta, Tb, and Tc are glass transition temperatures (K) of the monomers a, b, and c, respectively. The glass transition temperature is determined according to JIS K 7121.

If the other monomer is added, the aforesaid equation may also be applied.

### (B) Metal Oxide

Any metal oxide may be used as component (B). For instance, the metal oxide may be at least one of oxides of calcium, manganese, silicon, aluminum, zirconium, titanium, zinc, germanium, indium, tin, antimony or cerium, that is calcium oxide, manganese oxide, silicon dioxide, aluminum oxide, zirconium dioxide, titanium oxide, zinc oxide, germanium dioxide, indium oxide, tin oxide, antimony trioxide, and cerium oxide. Also preferably, at least one selected from oxides of manganese, silicon, aluminum, zirconium, titanium, zinc, germanium or indium whose powders are colored, that is, manganese oxide, silicon dioxide, aluminum oxide, zirconium dioxide, titanium oxide, zinc oxide, germanium dioxide, and indium oxide. More preferably, component (B) is titanium oxide, manganese oxide, or a mixture of these and a metal oxide selected from the above.

The average particle size of the metal oxide is not particularly limited, but is preferably 0.1 µm to 15 µm, and more preferably 0.2 µm to 10 µm. The average particle size of the metal oxide is a volume average particle size determined by a laser diffraction type particle size measuring device.

The amount of the (B) metal oxide in the coating composition is 20 to 95 parts by mass, preferably 20 to 90 parts by mass, based on 100 parts by mass of the total of the solid content of the component (A) and the amount of the component (B). Preferably, the amount of the metal oxide in the coating composition is 20 to 95% by mass, more preferably 20 to 90% by mass. If the amount of the metal oxide is less than the aforesaid lower limit, a hiding property is poor, so that design may not be changed. If the amount of the metal oxide is more than the aforesaid upper limit, dispersibility is poor, so that aggregation occurs in coating, which is not preferred.

The coating composition of the present invention is prepared by mixing the silicone acrylic copolymer resin emulsion (A) and the metal oxide (B) by a known mixing method in an aqueous system with a propeller type stirrer, homogenizer, ball mill, beads mill, or disperser mixer.

For example, component (A) and component (B) put in a disperser mixer, followed by stirred at 1000 rpm for 30 minutes to obtain the coating composition of the present invention.

A range of a drying temperature (MFT) for forming a coating of the coating composition is not particularly limited and is preferably 30° C. or lower. The hardness of the coating is not particularly limited, but preferably a pencil hardness of 2B to 4H, more preferably 2B to 2H. The hardness is determined according to JIS K5400-5-4.

Further, the coating composition of the present invention may comprise a pigment other than metal oxide in combination with the aforesaid metal oxide as long as it does not affect the performance of the present invention. Examples of the other pigment include iron oxide, perylene pigment, azo pigment, chrome yellow, red iron oxide, vermilion pigment, titanium yellow, cadmium red, quinacridone red, isoindoline, benzimidazolone, phthalocyanine green, phthalocyanine blue, cobalt blue, induslen blue and ultramarine. The amount of the pigment may be appropriately adjusted and is, for example, 10 to 60% by mass, preferably 20 to 50% by mass in the coating composition.

The coating composition of the present invention may further comprise an antioxidant, an ultraviolet absorber, an antifreezing agent, a pH regulator, an antiseptic, an anti-foaming agent, an anti-fungus agent, a mildew-proofing agent, a light stabilizer, an antistatic, a plasticizer, a flame retardant, a thickener, a surfactant, an organic solvent such as film-forming aid, and other resins.

A coating is formed by applying the present coating composition on one or both surfaces of a substrate such as a ceramic building material as a siding board, concrete, wood substrate, a metal substrate and a mortar substrate or by dipping a substrate in the present coating composition; and, then, drying the coating composition at room temperature to 150° C. to form a coating. The coating gives the advantages of a silicone resin such as water repellency, weather resistance, heat resistance, cold resistance, gas permeability, and sliding properties to the substrate for a long period of time, while maintaining the merits of the substrate.

Examples of the ceramic building material include a siding board.

Examples of the wood substrate include lumbers of the family Aceraceae, Betulaceae, Lauraceae, Castanea, Scrophulariaceae, Araucaria, Ulmaceae, Bignoniaceae, Rosaceae, Cupressaceae, Dipterocarpaceae, Myrtaceae, Fagaceae, Pinaceae, Leguminosae, and Oleaceae. The wood substrate is preferably dried by hot air at 20 to 150° C., particularly 50 to 150° C., for 0.5 to 5 hours. If the drying temperature is adjusted to 120° C. or lower, discoloration of the coating may be avoided.

Examples of the metal as the substrate include Si, Cu, Fe, Ni, Co, Au, Ag, Ti, Al, Zn, Sn, and Zr, and alloys thereof.

The method of applying the coating composition of the present invention on the substrate is not particularly limited and includes coating methods with various coaters such as gravure coater, bar coater, blade coater, roll coater, air knife coater, screen coater, and curtain coater; spray coating, dipping, and brushing.

The coating amount of the coating composition is not particularly limited. From the standpoint of stain resistance and coating workability, usually, the coating composition may preferably be applied in a coating amount of 1 to 300 g/m², more preferably 5 to 100 g/m² as a solid content, or at a dry coating thickness of 1 to 500 um, preferably 5 to 100 µm. Then, the composition is preferably naturally dried or heat-dried at a room temperature to 150° C. to form a film.

The heating and drying temperature is preferably 150° C. or lower, more preferably 120° C. or lower. The coating formed from the coating composition of the present invention may have an average light reflectance of 35% or more, preferably 40% or more and 75% or less, more preferably 45% or more and 73% or less in the wavelength range of 800 to 2500 nm. The light reflectance means the reflectance for heat ray energy during solar radiation. On account of having the aforesaid light reflectance, the present coating may provide the substrate excellent heat shielding property against solar heat.

The coating composition of the present invention is applied to an outer wall or as building exterior material to, thereby, give excellent heat shielding property, water repellency, water resistance, and stain resistance to the substrate. The coating composition of the present invention is a water-based coating composition. An article comprising a coating formed from the aforesaid coating composition has excellent heat shielding property, water repellency, water resistance, rain streak stain resistance, stain resistance, and weather resistance, while maintaining the original design of the substrate.

### EXAMPLES

The present invention will be explained below in further detail with reference to a series of the Examples and the Comparative Examples, though the present invention is in no way limited by these Examples.

Hereinafter, “part” or “%” represents part by mass or mass%, respectively. The weight average molecular weight was calculated from a specific viscosity, nsp, at 25° C. of a 1 g/100 ml solution in toluene of the polyorganosiloxane by the aforesaid method. The particle diameter of the resin emulsions obtained in the following Preparation Examples and Comparative Preparation Examples was determined by JEM-2100TM, ex JEOL.

### Method of Determining A Glass Transition Temperature Tg

The glass transition temperature Tg was determined by applying a load of 5 kgf to about 1 g of silicone acrylic copolymer resin powder obtained by spray drying and elevating a temperature at 5° C./min by a flow tester ex Shimadzu Corporation.

### Determination of a Solid Content

Approximately 1 g of each of the resin emulsion (sample) was placed in an aluminum foil dish and accurately weighed, placed in a dryer kept at about 105° C., left for 1 hour, taken out from the dryer, allowed to cool in a desiccator, and then weighed. A solid content was calculated by the following formula.

$$\text{R} \text{=} \frac{\text{T} - \text{L}}{\text{W} - \text{L}} \times 100$$

R: Solid content in %
W: Mass in gram of the aluminum foil dish and the undried sample
L: Mass in gram of the aluminum foil dish
T: Mass in gram of the aluminum foil dish and the dried sample
Dimensions of aluminum foil plate: 70 φ × 12 h (mm)

### Preparation of the Silicone Acrylic Copolymer Resin emulsion (A)

### Preparation Example 1

600 Grams of octamethylcyclotetrasiloxane, 0.48 g of y-methacryloxypropyl methyldiethoxysilane, a solution of 6 g of sodium lauryl sulfate in 54 g of pure water and a solution of 6 g of dodecylbenzene sulfonate in 54 g of pure water were placed in a 2 L beaker made of polyethylene, and uniformly emulsified by a homomixer, which was then diluted by adding 470 g of water little by little, and passed through a high-pressure homogenizer at a pressure of 300 kgf/cm² twice to obtain a uniform milky-white emulsion. The emulsion was transferred to a 2 L glass flask equipped with a stirrer, a thermometer and a reflux condenser, and allowed to polymerize at 55° C. for 24 hours, followed by aging at 15° C. for 24 hours and neutralization around a neutral point with 12 g of a 10% aqueous solution of sodium carbonate.

The structure of the polyorganosiloxane obtained by the polymerization was confirmed by ¹H-NMR and ²⁹Si-NMR (JNM-ECA600, determination solvent: CDC1₃; ¹H: frequency: 600 MHz, room temperature, integration times: 128; and ²⁹Si: frequency: 600 MHz, room temperature, integration times: 5000) . The polyorganosiloxane was represented by the following formula (1-1) and had an Mw (weight average molecular weight determined by the aforesaid method) of 250,000.

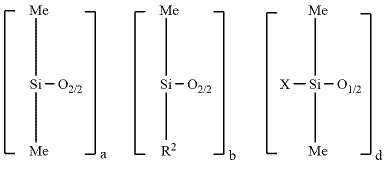

wherein R² is a Y-methacryloxypropyl group and X is a hydroxyl or ethoxy group and the proportions of a, b and d are shown in Table 1.

To the aforesaid neutralized reaction mixture (containing 534 g of the polyorganosiloxane obtained above), 232 g of methyl methacrylate (MMA) was added dropwise over a period of 3 to 5 hours under a redox reaction between a peroxide and a reducing agent at 30° C. to proceed acrylic copolymerization with the polyorganosiloxane to obtain a silicone acrylic copolymer resin emulsion having a solid content of 45.2%. The average particle diameter and solid content of the silicone acrylic copolymer resin emulsion are shown in Table 2.

### Preparation Example 2

600 Grams of octamethylcyclotetrasiloxane, 0.60 g of y-methacryloxypropyl methyldiethoxysilane, a solution of 6 g of sodium lauryl sulfate in 54 g of pure water and a solution of 6 g of dodecylbenzene sulfonate in 54 g of pure water were placed in a 2 L beaker made of polyethylene, and uniformly emulsified by a homomixer, which was then diluted by adding 470 g of water little by little, and passed through a high-pressure homogenizer at a pressure of 300 kgf/cm² twice to obtain a uniform milky-white emulsion. The emulsion was transferred to a 2 L glass flask equipped with a stirrer, a thermometer and a reflux condenser, and allowed to polymerize at 55° C. for 24 hours, followed by aging at 5° C. for 24 hours and neutralization around a neutral point with 12 g of a 10% aqueous solution of sodium carbonate.

The structure of the polyorganosiloxane obtained by the polymerization was confirmed by ¹H-NMR (JNM-ECA600, determination solvent: CDCl₃, determination conditions are same as those in Preparation Example 1). It was confirmed that the polyorganosiloxane was represented by the aforesaid formula (1-1) and had an Mw (weight average molecular weight determined by the aforesaid method) of 400,000.

In the aforesaid formula (1-1), R² is a y-methacryloxypropyl group and X is a hydroxyl or ethoxy group. The proportions of a, b and d are shown in Table 1.

To the aforesaid neutralized reaction mixture (containing 534 g of the polyorganosiloxane obtained above), 61 g of methyl methacrylate (MMA) was added dropwise over a period of 3 to 5 hours under a redox reaction between a peroxide and a reducing agent at 30° C. to proceed acrylic copolymerization with the polyorganosiloxane to obtain a silicone acrylic copolymer resin emulsion having a solid content of 44.8%. The average particle diameter and solid content of the silicone acrylic copolymer resin emulsion are shown in Table 2.

### Preparation Example 3

300 Grams of octamethylcyclotetrasiloxane, 300 g of diphenyldimethylsiloxane (KF-54, ex Shin-Etsu Chemical Co., Ltd), 0.96 g of y-methacryloxypropyl methyldiethoxysilane, a solution obtained by diluting 24 g of 50% sodium alkyl diphenyl ether disulfonate (Pelex SS-L, ex Kao Corporation) with 45 g of pure water, and a solution of 6 g of dodecylbenzene sulfonate in 54 g of pure water were placed in a 2 L beaker made of polyethylene, and uniformly emulsified by a homomixer, which was then diluted by adding 490 g of water little by little, and passed through a high-pressure homogenizer at a pressure of 300 kgf/cm² twice to obtain a uniform milky-white emulsion. The emulsion was transferred to a 2 L glass flask equipped with a stirrer, a thermometer and a reflux condenser, and allowed to polymerize at 55° C. for 10 to 20 hours, followed by aging at 10° C. for 10 to 20 hours and neutralization around a neutral point with 12 g of a 10 % aqueous solution of sodium carbonate.

The structure of the polyorganosiloxane obtained by the polymerization was confirmed by ¹H-NMR (JNM-ECA600, determination solvent: CDCl₃, determination conditions are same as those in Preparation Example 1). It was confirmed that the polyorganosiloxane was represented by the following formula (1-2) and had an Mw (weight average molecular weight determined by the aforesaid method) of 8,000.

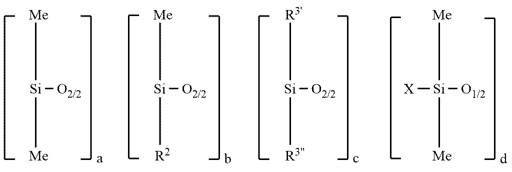

wherein R² is a y-methacryloxypropyl group, R³ʹ and R³ʺ are a phenyl or methyl group, at least one of R³ʹ and R³ʺ is a phenyl group, and X is a hydroxyl or ethoxy group and the proportions of a, b, c and d are shown in Table 1.

The emulsion obtained by the aforesaid neutralization had a nonvolatile content (solid content) of 47.5% after drying at 105° C. for 3 hours.

To the aforesaid neutralized reaction mixture (containing 534 g of the polyorganosiloxane obtained above), 242 g of methyl methacrylate (MMA) was added dropwise over a period of 3 to 5 hours under a redox reaction between a peroxide and a reducing agent at 30° C. to proceed acrylic copolymerization with the polyorganosiloxane to obtain a silicone acrylic copolymer resin emulsion having a solid content of 45.5%. The average particle diameter and solid content of the silicone acrylic copolymer resin emulsion are shown in Table 2.

### Preparation Example 4

600 Grams of octamethylcyclotetrasiloxane, 0.60 g of y-methacryloxypropyl methyldiethoxysilane, a solution of 6 g of sodium lauryl sulfate in 54 g of pure water and a solution of 6 g of dodecylbenzene sulfonate in 54 g of pure water were placed in a 2 L beaker made of polyethylene, and uniformly emulsified by a homomixer, which was then diluted by adding 470 g of water little by little, and passed through a high-pressure homogenizer at a pressure of 300 kgf/cm² twice to obtain a uniform milky-white emulsion. The emulsion was transferred to a 2 L glass flask equipped with a stirrer, a thermometer and a reflux condenser, and allowed to polymerize at 55° C. for 24 hours, followed by aging at 5° C. for 24 hours and neutralization around a neutral point with 12 g of a 10% aqueous solution of sodium carbonate.

The structure of the polyorganosiloxane obtained by the polymerization was confirmed by ¹H-NMR (JNM-ECA600, determination solvent: CDC1₃, determination conditions are same as those in Preparation Example 1). It was confirmed that the polyorganosiloxane was represented by the aforesaid formula (1-1) and had an Mw (weight average molecular weight determined by the aforesaid method) of 400,000.

In the aforesaid formula (1-1), R² is a y-methacryloxypropyl group and X is a hydroxyl or ethoxy group. The proportions of a, b and d are shown in Table 1.

To the aforesaid neutralized reaction mixture (containing 534 g of the polyorganosiloxane obtained above), 534 g of methyl methacrylate (MMA) was added dropwise over a period of 3 to 5 hours under a redox reaction between a peroxide and a reducing agent at 30° C. to proceed acrylic copolymerization with the polyorganosiloxane to obtain a silicone acrylic copolymer resin emulsion having a solid content of 45.1 %. The average particle diameter and solid content of the silicone acrylic copolymer resin emulsion are shown in Table 2.

### Comparative Preparation Example 1

The procedures of Preparation Example 1 were repeated to obtain a uniform milky-white emulsion. As in Preparation Example 1, the emulsion was transferred to a 2 L glass flask equipped with a stirrer, a thermometer and a reflux condenser, and allowed to polymerize at 55° C. for 24 hours, followed by aging at 15° C. for 24 hours and neutralization around a neutral point with 12 g of a 10% aqueous solution of sodium carbonate. It was confirmed that the polyorganosiloxane was represented by the aforesaid formula (1-1) and had an Mw (weight average molecular weight determined by the aforesaid method) of 250,000.

### Comparative Preparation Example 2

600 Grams of octamethylcyclotetrasiloxane, 0.60 g of y-methacryloxypropyl methyldiethoxysilane, and a solution of 6 g of sodium lauryl sulfate in 54 g of pure water and a solution of 6 g of dodecylbenzene sulfonate in 54 g of pure water were placed in a 2 L beaker made of polyethylene, and uniformly emulsified by a homomixer, which was then diluted by adding 470 g of water little by little, and passed through a high-pressure homogenizer at a pressure of 300 kgf/cm² twice to obtain a uniform milky-white emulsion. The emulsion was transferred to a 2 L glass flask equipped with a stirrer, a thermometer and a reflux condenser, and allowed to polymerize at 55° C. for 24 hours, followed by aging at 5° C. for 24 hours and neutralization around a neutral point with 12 g of a 10% aqueous solution of sodium carbonate.

The structure of the polyorganosiloxane obtained by the polymerization was confirmed by ¹H-NMR (JNM-ECA600, determination solvent: CDC1₃, determination conditions are same as those in Preparation Example 1). It was confirmed that the polyorganosiloxane was represented by the following formula (1-1) and had an Mw (weight average molecular weight) of 400,000. In the formula (1-1), R² is a y-methacryloxypropyl group and X is a hydroxyl or ethoxy group and the proportions of a, b and d are shown in Table 1.

To the aforesaid neutralized reaction mixture (containing 534 g of the polyorganosiloxane obtained above), 28 g of methyl methacrylate (MMA) was added dropwise over a period of 3 to 5 hours under a redox reaction between a peroxide and a reducing agent at 30° C. to proceed acrylic copolymerization with the polyorganosiloxane to obtain a silicone acrylic copolymer resin emulsion having a solid content of 44.0%. The average particle diameter and solid content of the silicone acrylic copolymer resin emulsion are shown in Table 2.

### Comparative Preparation Example 3

600 Grams of octamethylcyclotetrasiloxane, 0.60 g of y-methacryloxypropyl methyldiethoxysilane, and a solution of 6 g of sodium lauryl sulfate in 54 g of pure water and a solution of 6 g of dodecylbenzene sulfonate in 54 g of pure water were placed in a 2 L beaker made of polyethylene, and uniformly emulsified by a homomixer, which was then diluted by adding 470 g of water little by little, and passed through a high-pressure homogenizer at a pressure of 300 kgf/cm² twice to obtain a uniform milky-white emulsion. The emulsion was transferred to a 2 L glass flask equipped with a stirrer, a thermometer and a reflux condenser, and allowed to polymerize at 55° C. for 24 hours, followed by aging at 5° C. for 24 hours and neutralization around a neutral point with 12 g of a 10% aqueous solution of sodium carbonate.

The structure of the polyorganosiloxane obtained by the polymerization was confirmed by ¹H-NMR (JNM-ECA600, determination solvent: CDCl₃, determination conditions are same as those in Preparation Example 1). It was confirmed that the polyorganosiloxane was represented by the following formula (1-1) and had an Mw (weight average molecular weight) of 400,000. In the formula (1-1), R² is a y-methacryloxypropyl group and X is a hydroxyl or ethoxy group and the proportions of a, b and d are shown in Table 1.

To the aforesaid neutralized reaction mixture (containing 534 g of the polyorganosiloxane obtained above), 171 g of methyl methacrylate (MMA) and 57 g of butyl acrylate (BA) were added dropwise over a period of 3 to 5 hours under a redox reaction between a peroxide and a reducing agent at 30° C. to proceed acrylic copolymerization with the polyorganosiloxane to obtain a silicone acrylic copolymer resin emulsion having a solid content of 44.8 %. The average particle diameter and solid content of the silicone acrylic copolymer resin emulsion are shown in Table 2.

### Comparative Preparation Example 4

600 Grams of octamethylcyclotetrasiloxane and a solution of 6 g of sodium lauryl sulfate in 54 g of pure water and a solution of 6 g of dodecylbenzene sulfonate in 54 g of pure water were placed in a 2 L beaker made of polyethylene, and uniformly emulsified by a homomixer, which was then diluted by adding 470 g of water little by little, and passed through a high-pressure homogenizer at a pressure of 300 kgf/cm² twice to obtain a uniform milky-white emulsion. The emulsion was transferred to a 2 L glass flask equipped with a stirrer, a thermometer and a reflux condenser, and allowed to polymerize at 55° C. for 24 hours, followed by aging at 5° C. for 24 hours and neutralization around a neutral point with 12 g of a 10% aqueous solution of sodium carbonate.

The structure of the polyorganosiloxane obtained by the polymerization was confirmed by ¹H-NMR (JNM-ECA600, determination solvent: CDC1₃, determination conditions are same as those in Preparation Example 1). It was confirmed that the polyorganosiloxane was represented by the following formula (1-1) and had an Mw (weight average molecular weight) of 250,000. The proportions of a, b and d are shown in Table 1.

To the aforesaid neutralized reaction mixture (containing 534 g of the polyorganosiloxane obtained above), 232 g of methyl methacrylate (MMA) was added dropwise over a period of 3 to 5 hours under a redox reaction between a peroxide and a reducing agent at 30° C. to proceed acrylic copolymerization with the polyorganosiloxane to obtain a silicone acrylic copolymer resin emulsion having a solid content of 45.2%. The average particle diameter and solid content of the silicone acrylic copolymer resin emulsion are shown in Table 2.

In the resin obtained in Comparative Preparation Example 4, the organopolysiloxane does not have a y-methacryloxypropyl group, so that MMA was not graft-polymerized to the organopolysiloxane.

### Comparative Preparation Example 5

912 Grams of ethyl acrylate, 101 g of 2-hydroxyethyl methacrylate, 52 g of Aqualon KH-1025 (ex DKS Co. Ltd.), 16 g of Noigen EA-177 (ex DKS Co. Ltd.), 10 g of Persol KMN-1 (ex Miyoshi Oil & Fat Co., Ltd) and 170 g of ion-exchanged water were placed in an emulsification tank and emulsified with a homomixer. 884 g of ion-exchanged water and 1.8 g of ammonium persulfate were put in a 3 L-four-neck separable flask and dissolved. Then, the air in the flask is substituted with nitrogen and the temperature was raised to 80° C. To which, 2.6 g of ammonium persulfate dissolved in 70 g of ion-exchanged water and the aforesaid emulsion were simultaneously added dropwise over 5 to 6 hours. Finally, perbutyl H69 and vitamin C were added to the mixture and aged for 2 hours to obtain an acrylic resin emulsion having a solid content of 45.0%.

### Comparative Preparation Example 6

The procedures of Preparation Example 1 were repeated to obtain a uniform milky-white emulsion. As in Preparation Example 1, the emulsion was transferred to a 2 L glass flask equipped with a stirrer, a thermometer and a reflux condenser, and allowed to polymerize at 55° C. for 24 hours, followed by aging at 15° C. for 24 hours and neutralization around a neutral point with 12 g of a 10% aqueous solution of sodium carbonate. It was confirmed that the polyorganosiloxane was represented by the aforesaid formula (1-1) and had an Mw (weight average molecular weight determined by the aforesaid method) of 250,000.

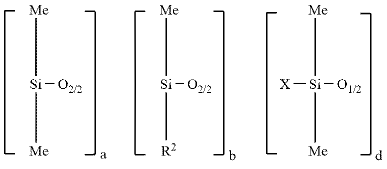

wherein R² is a y-methacryloxypropyl group and X is a hydroxyl or ethoxy group and the proportions of a, b and d are shown in Table 1.

To the aforesaid neutralized reaction mixture (containing 534 g of the polyorganosiloxane obtained above), 1246 g of methyl methacrylate (MMA) was added dropwise over a period of 3 to 5 hours under a redox reaction between a peroxide and a reducing agent at 30° C. to proceed acrylic copolymerization with the polyorganosiloxane to obtain a silicone acrylic copolymer resin emulsion having a solid content of 45.5%. The average particle diameter and solid content of the silicone acrylic copolymer resin emulsion are shown in Table 2.

TABLE 1

| | Preparation Example | | | | Comparative Preparation Example | | | | | |
|---|---|---|---|---|---|---|---|---|---|---|
| | 1 | 2 | 3 | 4 | 1 | 2 | 3 | 4 | 5 | 6 |
| Mass proportion of the raw materials for polyorganosiloxane (al) | | | | | | | | | | |
| D4 | 100 | 100 | 50 | 100 | 100 | 100 | 100 | 100 | - | 100 |
| KF-54 | 0 | 0 | 50 | 0 | 0 | 0 | 0 | 0 | - | 0 |
| sodium lauryl sulfate | 1 | 1 | - | 1 | 1 | 1 | 1 | 1 | - | 1 |
| Pelex SS-L | - | - | 2 | - | - | - | - | - | - | - |
| dodecylbenzene sulfonate | 1 | 1 | 1 | 1 | 1 | 1 | 1 | 1 | - | 1 |
| y-methacryloxypropyl methyldiethoxysilane | 0.08 | 0.1 | 0.16 | 0.08 | 0.08 | 0.08 | 8.7 | 0 | - | 0.08 |
| Proportions of α to d in polyorganosiloxane (a1), based on a total 100 of α to d | | | | | | | | | | |
| α | 99.91 | 99.93 | 67.22 | 99.91 | 99.91 | 99.91 | 93.94 | 99.94 | - | 99.91 |
| b | 0.03 | 0.03 | 0.48 | 0.03 | 0.03 | 0.03 | 6 | 0 | - | 0.03 |
| c | 0 | 0 | 28.5 | 0 | 0 | 0 | 0 | 0 | - | 0 |
| d | 0.06 | 0.04 | 3.8 | 0.06 | 0.06 | 0.06 | 0.06 | 0.06 | - | 0.06 |

D4:octamethyl cyclotetrasiloxane
KF-54:diphenyl dimethyl siloxane
Pelex SS-L: 50% sodium alkyl diphenyl ether disulfonate

TABLE 2

| | | Preparation Example | | | | Comparative Preparation Example | | | | | |
|---|---|---|---|---|---|---|---|---|---|---|---|
| | | 1 | 2 | 3 | 4 | 1 | 2 | 3 | 4 | 5 | 6 |
| Mass ratio | (al) Polyorganosiloxane | 70 | 90 | 70 | 50 | 100 | 95 | 70 | 70 | - | 30 |
| | (a2) Methyl methacrylate | 30 | 10 | 30 | 50 | - | 5 | 22.5 | 30 | - | 70 |
| | (a2) Butyl acrylate | - | - | - | - | - | - | 7.5 | - | - | - |
| Emulsion | Av. particle diameter, nm | 240 | 230 | 240 | 250 | 240 | 240 | 240 | 240 | 180 | 250 |
| | Solid content, % | 45.2 | 45.0 | 45.3 | 45.1 | 45.5 | 44.0 | 45.3 | 45.1 | 45.2 | 45.5 |
| | Tg, °C | 110 | 105 | 110 | 110 | <0 | 100 | 50 | 110 | -15 | 110 |

Comparative Preparation Example 5 provided an acrylic resin emulsion having no organopolysiloxane structure.

### Preparation of a Coating Composition

### Examples 1 to 8 and Comparative Examples 1 to 7

The silicone acrylic copolymer resin emulsion obtained in Preparation Examples 1 to 4 or Comparative Preparation Examples 1 to 6 and Typake JR-1000 (titanium oxide having about 1 µm, ex TAYCA Corporation) were stirred with a disperser mixer for 10 minutes to obtain a coating composition. The amount of solid content contained in the coating composition is as shown in Table 3.

### Examples 9 to 12 and Comparative Examples 8 to 12

The silicone acrylic copolymer resin emulsion obtained in Preparation Examples 1 to 4 or Comparative Preparation Examples 1 to 6 and R-38L (titanium oxide having about 0.4 µm, ex. Sakai Chemical Industry Co., Ltd.) were stirred with a disperser mixer for 10 minutes to obtain a coating composition. The amount of solid content contained in the coating composition is as shown in Table 4.

### Examples 13 to 15 and Comparative Examples 13 to 15

The silicone acrylic copolymer resin emulsion obtained in Preparation Examples 1 to 4 or Comparative Preparation Examples 1 to 6 and Typake Black SG-101 (black pigment having 0.4 µm and composed of calcium oxide, titanium oxide and manganese oxide, ex Ishihara Sangyo Co., Ltd.) were stirred with a disperser mixer for 10 minutes to obtain a coating composition. The amount of solid content contained in the coating composition is as shown in Table 5.

### Sedimentation Stability

The coating composition was placed in a 200 mL glass bottle and stored at room temperature. The changes in appearance were visually observed.

Good “G”: The coating composition was stable without gelling for more than 2 weeks.

Poor “P”: The coating composition was gelled when mixed.

### Method for Coating

The coating compositions were each applied on a PET film or black-and-white concealing paper by a bar coater to give a dry film thickness of 35 to 40 µm and, then, left to stand at room temperature for 2 days to form coatings.

The feel, static and dynamic friction coefficients, and light reflectance of the coating films were evaluated in the following manners.

### Static/Dynamic Friction Coefficient and Feel

The static/dynamic friction coefficient of the coating films formed on the PET film was evaluated in the following manner.

A friction force was determined using HEIDON TYPE-38 (ex SHINTO Scientific Co. Ltd.), wherein a metal depressor of 200 g weight was brought into vertical contact with the film at a right angle and moved at a speed of 3 cm/min to determine a friction force. A static friction coefficient and a dynamic friction coefficient were calculated from the friction force.

When the coating film showed a static friction coefficient of less than 1.0, a dynamic friction coefficient of less than 0.5, and a difference of between the static friction coefficient and the dynamic friction coefficient, i.e. [static friction coefficient value] -[dynamic friction coefficient value], of less than 0.5, the feel was evaluated as Good.

When the difference between the static friction coefficient and the dynamic friction coefficient is 0.5 or more, it seems that the feel of the film is greatly reduced.

### Water Contact Angle

The following test was performed using the film applied to the PET film.

On the coating film, a droplet of 0.2 µL of ion-exchanged water was contacted. After thirty seconds, the contact angle of the droplet was determined by an automatic contact angle meter DMO-601 (ex Kyowa Interface Science Co., Ltd.).

### Light Reflectance

The following test was performed using the film applied to the black-and-white concealing paper.

The reflectance of the film at a wavelength of 800 nm to 2500 nm was determined by the NIR measuring machine NIRFlex N-500 (ex BUCHI, Japan), and the average reflectance at the integrated value in the wavelength range was calculated. The average reflectance is shown in the table below as the solar reflectance (light reflectance). Those having an average reflectance of 35% or more were considered to be good.

TABLE 3

| | | | | Example | | | | | | | |
|---|---|---|---|---|---|---|---|---|---|---|---|
| | | | | 1 | 2 | 3 | 4 | 5 | 6 | 7 | 8 |
| Component, part by mass | (A) | Preparation | 1 | 100 | - | - | - | 20 | 50 | 100 | 100 |
| | | | 2 | - | 100 | - | - | - | - | - | - |
| | | | 3 | - | - | 100 | - | - | - | - | - |
| | | | 4 | - | - | - | 100 | - | - | - | - |
| | (C) | Comparative Preparation | 5 | - | - | - | - | 80 | 50 | - | - |
| | (B) | Titanium oxide, 1 µm | | 57 | 57 | 57 | 57 | 57 | 57 | 19 | 95 |
| | Solid content in the composition, % | | | 64.1 | 63.6 | 64.3 | 65.4 | 65.0 | 64.8 | 53.7 | 65.0 |
| Solid content | Solid content of component (A) | | | 44.1 | 44.1 | 44.1 | 44.1 | 13.6 | 28.2 | 70.3 | 13.6 |
| | Component (B) | | | 55.9 | 55.9 | 55.9 | 55.9 | 86.4 | 71.8 | 29.7 | 86.4 |
| | Component (C) ^{note)} | | | - | - | - | - | 54.5 | 28.2 | - | - |
| Evaluation | Sedimentation stability | | | G | G | G | G | G | G | G | G |
| | Static friction coefficient | | | 0.39 | 0.42 | 0.5 | 0.41 | 0.84 | 0.59 | 0.39 | 0.76 |
| | Dynamic friction coefficient | | | 0.28 | 0.24 | 0.38 | 0.29 | 0.37 | 0.16 | 0.29 | 0.48 |
| | Feel | | | G | G | G | G | G | G | G | G |
| | Contact angle, ° | | | 100 | 110 | 108 | 119 | 100 | 104 | 100 | 104 |
| | Average reflectance, % | | | 69 | 68 | 62 | 58 | 57 | 62 | 52 | 71 |

note) The amount of component (C) is the solid content of the emulsion obtained in Comparative Preparation Example 5.

TABLE 4

| | | | | Comparative Example | | | | | | |
|---|---|---|---|---|---|---|---|---|---|---|
| | | | | 1 | 2 | 3 | 4 | 5 | 6 | 7 |
| Component, part by mass | (C) | Comparative Preparation | 1 | 100 | - | - | - | - | 70 | - |
| | (A’) | | 2 | - | 100 | - | - | - | - | - |
| | | | 3 | - | - | 100 | - | - | - | - |
| | | | 4 | - | - | - | 100 | - | - | - |
| | (C) | | 5 | - | - | - | - | 100 | 30 | - |
| | (A’) | | 6 | - | - | - | - | - | - | 100 |
| | (B) | Titanium oxide, 1 µm | | 57 | 57 | 57 | 57 | 57 | 57 | 57 |
| | Solid content in the composition, % | | | 65.2 | 64.1 | 64.8 | 64.4 | 65.3 | 65.5 | 65.3 |
| Solid content | Solid content of component (A’) ^{note} 1) | | | - | 44.1 | 44.1 | 44.1 | - | - | 44.1 |
| | Component (B) | | | 100.0 | 55.9 | 55.9 | 55.9 | 100.0 | 100.0 | 55.9 |
| | Component (C) ^{note} 1) | | | 78.9 | - | - | - | 78.9 | 78.9 | - |
| Evaluation | Sedimentation stability | | | P | P | P | P | G | P | P |
| | Static friction coefficient | | | N/A^{note2)} | | | | 2.39 | N/A^{note2)} | |
| | Dynamic friction coefficient | | | | | | | 1.31 | | |
| | Feel | | | | | | | P | | |
| | Contact angle, ° | | | | | | | 21 | | |
| | Average reflectance, % | | | | | | | 27 | | |

note 1) The amount of component (A’) is the solid content of the emulsion obtained in Comparative Preparation Examples 2 to 4 or 6, and the amount of component (C) is the solid content of the emulsion obtained in Comparative Preparation Example 1 or 5.
note 2) The compositions of Comparative Examples 1 to 4, 6 and 7 gelled during preparation and the evaluations could not be conducted.

TABLE 5

| | | | | Example | | | | Comparative Example | | | | |
|---|---|---|---|---|---|---|---|---|---|---|---|---|
| | | | | 9 | 10 | 11 | 12 | 8 | 9 | 10 | 11 | 12 |
| Compon ent, part by mass | (A) | Preparation | 1 | 100 | - | - | - | - | - | - | - | - |
| | | | 2 | - | 100 | - | - | - | - | - | - | - |
| | | | 3 | - | - | 100 | - | - | - | - | - | - |
| | | | 4 | - | - | - | 100 | - | - | - | - | - |
| | (C) | Com. Preparation | 1 | - | - | - | - | 100 | - | - | - | - |
| | (A’) | | 2 | - | - | - | - | - | 100 | - | - | - |
| | | | 3 | - | - | - | - | - | - | 100 | - | - |
| | | | 4 | - | - | - | - | - | - | - | 100 | - |
| | (C) | | 5 | - | - | - | - | - | - | - | - | 100 |
| | (B) | Titanium oxide, 0.4 µm | | 54 | 54 | 54 | 54 | 54 | 54 | 54 | 54 | 54 |
| | Solid content in the composition, % | | | - | 64.4 | 64.7 | 64.5 | 64.6 | 65.5 | 64.7 | 64.7 | 64.9 |
| Solid content | Solid content of component (A)or(A’) | | | 44.1 | 44.1 | 44.1 | 44.1 | - | 44.1 | 44.1 | 44.1 | - |
| | Component (B) | | | 55.9 | 55.9 | 55.9 | 55.9 | 100.0 | 55.9 | 55.9 | 55.9 | 55.9 |
| | Component (C) ^{note1)} | | | - | - | - | - | 44.1 | - | - | - | 44.1 |
| Evaluati on | Sedimentation stability | | | G | G | G | G | P | P | P | P | G |
| | Static friction coefficient | | | 0.41 | 0.37 | 0.56 | 0.46 | N/A ^{note2)} | | | | 2.55 |
| | Dynamic friction coefficient | | | 0.29 | 0.24 | 0.44 | 0.27 | | | | | 1.35 |
| | Feel | | | G | G | G | G | | | | | P |
| | Contact angle, ° | | | 103 | 109 | 104 | 115 | | | | | 21 |
| | Average reflectance, % | | | 66 | 64 | 59 | 59 | | | | | 23 |

note 1) The amount of component (C) is the solid content of the emulsion obtained in Comparative Preparation Example 1 or 5.
note 2) The compositions of Comparative Examples 8 to 11 gelled during preparation and the evaluations could not be conducted.

TABLE 6

| | | | | Example | | | Comparative Example | | |
|---|---|---|---|---|---|---|---|---|---|
| | | | | 13 | 14 | 15 | 13 | 14 | 15 |
| Component, part by mass | (A) | Preparation | 1 | 100 | - | - | - | - | - |
| | | | 2 | - | 100 | - | - | - | - |
| | | | 3 | - | - | - | - | - | - |
| | | | 4 | - | - | 100 | - | - | - |
| | (C) | Comparative Preparation | 1 | - | - | - | 100 | - | - |
| | (A’) | | 2 | - | - | - | - | 100 | - |
| | | | 3 | - | - | - | - | - | - |
| | | | 4 | - | - | - | - | - | - |
| | (C) | | 5 | - | - | - | - | - | 100 |
| | (B) | Mixture of calcium oxide, titanium oxide, and manganese oxide | | 55 | 55 | 55 | 55 | 55 | 55 |
| | Solid content in the composition, % | | | 64.8 | 65.1 | 64.8 | 64.8 | 65.0 | 65.2 |
| Solid content | | Solid content of component (A)or(A’) | | 44.1 | 44.1 | 44.1 | - | 44.1 | - |
| | | Component (B) | | 55.9 | 55.9 | 55.9 | 55.9 | 55.9 | 55.9 |
| | | Component (C) ^{note} ¹⁾ | | - | - | - | 44.1 | - | 44.1 |
| Evaluation | | Sedimentation stability | | G | G | G | P | P | G |
| | | Static friction coefficient | | 0.51 | 0.4 | 0.68 | N/A ^{note} ²⁾ | | 2.68 |
| | | Dynamic friction coefficient | | 0.39 | 0.21 | 0.41 | | | 1.41 |
| | | Feel | | G | G | G | | | P |
| | | Contact angle, ° | | 107 | 111 | 109 | | | 21 |
| | | Average reflectance, % | | 53 | 51 | 49 | | | 33 |

note 1) The amount of component (C) is the solid content of the emulsion obtained in Comparative Preparation Example 1 or 5.
note 2) The compositions of Comparative Examples 13 and 14 gelled during preparation and the evaluations could not be conducted.

As seen in Tables 4 to 6, in the coating composition comprising the silicone resin emulsions and metal oxide of Comparative Preparation Examples 1 and 4 and the coating composition comprising the silicone acrylic copolymer resin emulsions and metal oxides of Comparative Preparation Examples 2, 3 and 6, the metal oxide aggregated and gelled during the preparation of the coating composition. The coating composition comprising the acrylic resin emulsion and metal oxide of Comparative Preparation Example 5 had good sedimentation stability, but was inferior in heat shielding property, poor feel, and poor water repellency of the film.

In contrast, the coating composition of the present invention forms a coating having heat shielding property, excellent feel and water repellency. The aforesaid coating gives excellent heat shielding property, excellent feel and water repellency to a substrate while maintaining the design specific to the substrate. The coating composition of the present invention is water-based and, therefore, advantageous from the standpoints of workability and environment. The coating composition also has excellent storage stability. The water-based coating composition of the present invention is suited for an outer wall coating to suppress temperature rising by solar heat.

1. A coating composition wherein the coating composition comprises the following components (A) and (B),
(A) an emulsion of a silicone acrylic copolymer resin having a glass transition temperature of 0° C. or higher and being a copolymer of 40 to 90 parts by mass of (a1) a polyorganosiloxane represented by the following formula (1) with 10 to 60 parts by mass of (a2) a methacrylic acid ester monomer, provided that a total amount of components (a1) and (a2) is 100 parts by mass, 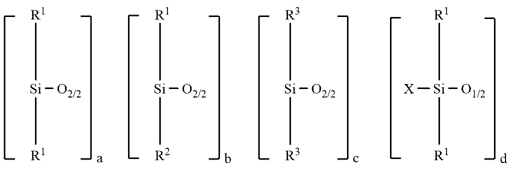
wherein R¹ is, independently of each other, a substituted or unsubstituted monovalent hydrocarbon group having 1 to 20 carbon atoms, precluding the groups defined for R² and a phenyl group; R² is, independently of each other, an alkenyl group having 2 to 6 carbon atoms or an alkyl group which has 1 to 6 carbon atoms and of which a part of the hydrogen atoms bonded to the carbon atom is substituted with a mercapto group, a vinyl group, an acryloxy group, or a methacryloxy group; R³ is, independently of each other, a phenyl group or the group defined for R¹, and at least one of R³s bonded to the same silicon atom is a phenyl group; and X is, independently of each other, a substituted or unsubstituted monovalent hydrocarbon group having 1 to 20 carbon atoms, an alkoxy group having 1 to 20 carbon atoms, or a hydroxyl group; a, b, c and d are the number satisfying equations, 0.11≤a/(a+b+c+d)<1, 0.00001≤b/(a+b+c+d)≤0.05, 0≤c/(a+b+c+d)≤0.6, and 0.000001≤d/(a+b+c+d)≤0.24;
the emulsion being in an amount of 5 to 80 parts by mass as a solid content, and
(B) a metal oxide in an amount of 20 to 95 parts by mass, provided that a total mass of the solid content of component (A) and component (B) is 100 parts by mass.

2. The coating composition according to claim 1, wherein the metal oxide (B) is at least one selected from the groups consisting of oxides of calcium, manganese, silicon, aluminum, zirconium, titanium, zinc, germanium, indium, tin, antimony and cerium.

3. The coating composition according to claim 1, wherein the particles of the emulsion of the silicone acrylic copolymer resin (A) have an average particle diameter of 100 nm to 1200 nm.

4. The coating composition according to claim 1, being used for coating outer wall or exterior of building.

5. A coating formed from the coating composition according to claim 1.

6. The coating according to claim 5 having an average light reflectance of 35% or more in the wavelength range of 800 to 2500 nm.

7. The coating according to claim 5, wherein a difference between a static friction coefficient and a dynamic friction coefficient is less than 0.5.

8. An article comprising a substrate and the coating according to claim 5, wherein the coating being present on one or both surfaces of the substrate.

9. The article according to claim 8, wherein the substrate is selected from the group consisting of a ceramic building material, concrete, wood substrate, a metal substrate and a mortar substrate.

10. A building material for an outer wall, wherein the building material comprises the article according to claim 8.

11. A building material for a building exterior, wherein the building material comprises the article according to claim 8.

12. The coating composition according to claim 2, wherein the particles of the emulsion of the silicone acrylic copolymer resin (A) have an average particle diameter of 100 nm to 1200 nm.

13. A coating formed from the coating composition according to claim 2.

14. A coating formed from the coating composition according to claim 3.

15. A coating formed from the coating composition according to claim 12.

16. The coating according to claim 6, wherein a difference between a static friction coefficient and a dynamic friction coefficient is less than 0.5.

17. An article comprising a substrate and the coating according to claim 6, wherein the coating being present on one or both surfaces of the substrate.

18. An article comprising a substrate and the coating according to claim 7, wherein the coating being present on one or both surfaces of the substrate.

19. A building material for an outer wall, wherein the building material comprises the article according to claim 9.

20. A building material for a building exterior, wherein the building material comprises the article according to claim 9.
